(19) United States
(12) Patent Application Publication
(10) Pub. No.: US 2016/0094585 A1
(43) Pub. Date: Mar. 31, 2016

(54) SECURE POLICY PORTAL FOR REMOTE STORAGE NETWORKS

(71) Applicant: Limelight Networks, Inc., Tempe, AZ (US)

(72) Inventors: Alexander Shahbazian, Tempe, AZ (US); Mohan Kokal, Peoria, AZ (US); Brad Harvell, Chandler, AZ (US)

(73) Assignee: LIMELIGHT NETWORKS, INC., Tempe, AZ (US)

(21) Appl. No.: 14/500,686

(22) Filed: Sep. 29, 2014

(51) Int. Cl. H04L 29/06

(52) U.S. Cl. CPC H04L 63/205; H04L 63/105

(57) ABSTRACT

A system for securely managing uploaded content according to client-definable policies in remote storage configurations may include a content storage network with servers that are distributed in a plurality of geographic regions. The system may also include a policy engine that stores and processes policies that govern how content uploaded to the content storage network is stored. The system may additionally include a client portal that may be configured to receive a content object at the client device for upload to the content storage network, receive a policy or a selection of a policy that governs how the content object should be stored in the content storage network, and provide a status of how the policy is applied to the content object after the content object is uploaded to the content storage network.

### BACKGROUND OF THE INVENTION

A content delivery network (CDN) is a large distributed system of servers deployed in multiple data centers throughout the Internet. The goal of a CDN is to serve content to end-users with high availability and high performance. Besides better performance and availability, CDNs also offload the traffic served directly from the content provider's origin infrastructure. CDNs can include geographically distributed points of presence (POPs) to locate edge servers close to end users. CDNs are capable of delivering content in high demand with higher quality of service (QoS). Content can be requested from a CDN using a universal resource locator (URL). Various techniques are used to route a URL request to a nearby POP, for example, in order to efficiently retrieve content.

### BRIEF SUMMARY OF THE INVENTION

In one embodiment, a system for securely managing uploaded content according to client-definable policies in remote storage configurations may be presented. The system may include a content storage network that may include a plurality of servers that are distributed in a plurality of geographic regions. The system may also include a policy engine that stores and processes policies that govern how content uploaded to the content storage network is stored on the plurality of servers throughout the plurality of geographic regions. The system may additionally include a client portal deployable to a client device for managing content in the content storage network. The client portal may be configured to receive a content object at the client device for upload to the content storage network, receive a policy or a selection of a policy that governs how the content object should be stored in the content storage network, and provide a status of how the policy is applied to the content object after the content object is uploaded to the content storage network.

In another embodiment, a method for securely managing uploaded content according to client-definable policies in remote storage configurations may be presented. The method may include receiving, at a client portal, a content object from a client device for upload to a content storage network. In some embodiments, the client portal may deployable to the client device for managing content in the content storage network, and the content storage network may include a plurality of servers that are distributed in a plurality of geographic regions. The method may also include receiving, at the client portal, a policy or a selection of a policy that governs how the content object should be stored in the content storage network. In some embodiments, a policy engine may store and process policies that govern how content uploaded to the content storage network is stored on the plurality of servers throughout the plurality of geographic regions. The method may additionally include providing a status of how the policy is applied to the content object after the content object is uploaded to the content storage network.

A number of different configurations may also be presented and included individually or in combination with each embodiment. The content storage network may include a content delivery network (CDN), the plurality of servers may include a plurality of edge servers organized into a plurality of geographically distributed Points of Presence (POPs) in the CDN, and the policy that governs how the content object should be stored in the content storage network may govern how copies of the content object should be distributed to the plurality of geographically distributed POPs. The client portal may provide a progress indicator while the content object is being uploaded. The client portal may accept inputs that define elements of the policy. The client portal may detect a time interval between when the content object is uploaded and when the content object conforms with the policy, and during the time interval, the status of how the policy is applied to the content object may indicate that the content object does not yet conform to the policy. The client portal may detect when the content object has been uploaded and when storage of the content object in the content storage network conforms to the policy, and after the time interval, the status of how the policy is applied to the content object may indicate that the content object conforms to the policy. The client portal may include a mountable file system in client space that provides virtualized access to the content object after it has been uploaded into the content storage network. The client portal may transparently encrypt the content object before the content object is uploaded to the content storage network and decrypt the content object when the content object is downloaded to the client portal. Cryptographic keys for decrypting and/or encrypting the content object may be stored at the client portal and are not accessible by the content storage network. The client portal may receive a request to display contents of the content storage network according to a view, access one or more content objects stored in the content storage network that are associated with the view, decrypt one or more blocks for each of the one or more content objects, wherein the one or more blocks include preview information, and cause the preview information to be displayed in an unencrypted form at the client portal.

### BRIEF DESCRIPTION OF THE DRAWINGS

The subject matter that is regarded as the invention is particularly pointed out and distinctly claimed in the claims at the conclusion of the specification. The foregoing and other objects, features, and advantages will be apparent from the following detailed description taken in conjunction with the accompanying drawings.

FIG. 1 illustrates a block diagram of a content distribution system, according to some embodiments.

FIG. 2 illustrates a block diagram of an embodiment of a content delivery network (CDN), according to some embodiments.

FIG. 3 illustrates a block diagram of another embodiment of a content distribution system, according to some embodiments.

FIG. 4 illustrates a block diagram of a system for securely managing policy-based content uploads and storage, according to some embodiments.

FIG. 5 illustrates a block diagram of a policy engine, according to some embodiments.

FIG. 6 illustrates a block diagram of a client portal, according to some embodiments.

FIG. 7 illustrates a flowchart of a method for securely managing policy-based content uploads and storage, according to some embodiments.

FIG. 8 illustrates an interface that may be presented by the client portal, according to some embodiments.

FIG. 9 illustrates a flowchart of a method for securely providing content object previews in the client portal, according to some embodiments.

FIG. 10 illustrates a block diagram of a client portal performing block decryption for content previews, according to some embodiments.

FIG. 11 illustrates an interface that may be presented by the client portal for securely providing content object previews, according to some embodiments.

FIG. 12 illustrates a flowchart of a method for prioritizing upload timing, according to one embodiment.

FIG. 13 illustrates one example of a computer system, according to some embodiments.

### DETAILED DESCRIPTION OF THE INVENTION

The ensuing description provides descriptions of exemplary embodiments only, and is not intended to limit the scope, applicability, or configuration of the disclosure. Rather, the ensuing description of the exemplary embodiments will provide those skilled in the art with an enabling description for implementing the embodiments of the claims. It will be understood that various changes may be made in the function and arrangement of elements without departing from the spirit and scope as set forth in the appended claims.

### Content Delivery Networks

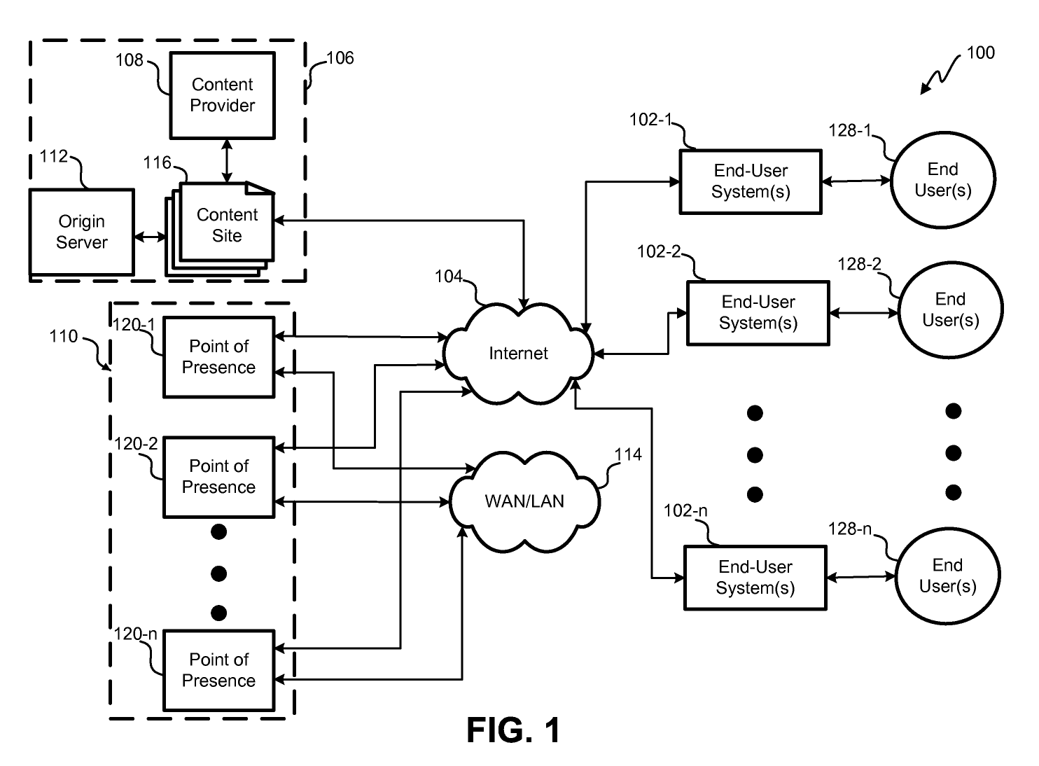

Referring first to FIG. 1, a block diagram of an embodiment of a content distribution system 100 is shown. The content originator 106 offloads delivery of the content objects to a content delivery network (CDN) 110. The content originator 106 produces and/or distributes content objects and includes a content provider 108, a content site 116, and an origin server 112. The CDN 110 can both cache and/or host content in various embodiments for third parties to offload delivery and typically provide better quality of service (QoS) to a broad spectrum of end-user systems 102 distributed geographically. The content originator 106 is the customer of the CDN 110 and an end user 128 benefits from improvements in QoS.

In this embodiment, the content distribution system 100 locates the content objects (or portions thereof) and distributes the content objects to an end-user system 102. The content objects are dynamically cached within the CDN 110 and/or hosted by the CDN 110. A content object is any content file, content stream, or a range defining a segment of a content file or content stream, and could include, for example, video, pictures, data, audio, software, and/or text. The content object could be live, delayed, or stored. The range defining a segment could be defined as a byte range or time range within the playback. Throughout the specification, references may be made to a content object, content, content stream and/or content file, but it is to be understood that those terms could be used interchangeably wherever they may appear.

Many content providers 108 use a CDN 110 (or multiple CDNs) to deliver the content objects over the Internet 104 to end users 128. The CDN 110 includes a number of points of presence (POPs) 120, which are geographically distributed through the content distribution system 100 to deliver content. Various embodiments may have any number of POPs 120 within the CDN 110 that are generally distributed in various locations around the Internet 104 so as to be proximate to end-user systems 102. Multiple POPs 120 use the same IP address such that an Anycast routing scheme is used to find a POP likely to be close to the end-user system 102, in a network sense, for each request. In addition to the Internet 104, a wide area network (WAN) and/or local area network (LAN) 114 or other backbone may couple the POPs 120 with each other and also couple the POPs 120 with other parts of the CDN 110. Distributed storage, processing, and caching is provided by the CDN 110.

When an end user 128 requests a web page (or other content) through its respective end-user system 102, the request for the web page is passed either directly or indirectly via the Internet 104 to the content originator 106. The content originator 106 is the source or re-distributor of content objects, i.e., the so-called origin server 112. The content site 116 is an Internet web site accessible by the end-user system 102. In one embodiment, the content site 116 could be a web site where the content is viewable with a web browser. In other embodiments, the content site 116 could be accessible with application software other than a web browser. The content provider 108 directs content requests to a CDN 110 after they are made or formulates the delivery path by embedding the delivery path into a uniform resource identifier (URI) for a web page. In any event, the request for content is handed over to the CDN 110 in this embodiment by using an Anycast IP address corresponding to two or more POPs 120. In some embodiments, the CDN 110 hosts content objects and/or web pages, thus acting as the origin server 112.

Once the request for a content object is passed to the CDN 110, the request is associated with a particular POP 120 within the CDN 110 using the Anycast routing scheme, but other embodiments could use routing, redirection, or DNS to shunt requests to a particular POP 120. It is noted that the CDN 110 processes requests for content in the application layer of the open systems interconnection (OSI) model with URIs, URLs, and HTTP. The particular POP 120 may retrieve the portion of the content object from the content provider 108, where the content originator 106 is hosting the origin server 112. Alternatively, the content provider 108 may directly provide the content object to the CDN 110 and POPs 120 associated with the CDN 110 through pre-population of caches (i.e., in advance of the first request) or hosting. A storage policy could be defined to specify the conditions under which pre-population is performed. In this embodiment, content objects are provided to the CDN 110 and stored in one or more CDN servers such that the portion of the requested content may be hosted from the CDN 110. The CDN servers include edge servers in each POP 120 that serve end-user requests. The origin server 112 holds a copy of each content object for the content originator 106. Periodically, the content of the origin server 112 may be reconciled with the CDN 110 through a caching, hosting, and/or pre-population algorithm, for example, through a storage policy. Some content providers 108 could use an origin server 112 within the CDN 110 to host the content and avoid the need to maintain a copy.

Once the content object is retrieved, the content object is stored within the particular POP 120 and is served from that POP to the end-user system 102. The end-user system 102 receives the content object and processes the content object for use by the end user 128. The end-user system 102 could be a personal computer, media player, handheld computer, tablet, pad, Internet appliance, phone, smart phone, IPTV set top, streaming radio, or any other device that receives and plays content objects. In some embodiments, a number of the end-user systems 102 could be networked together. Although this embodiment shows only a single content originator 106 and a single CDN 110, it is to be understood that there could be many of each in various embodiments.

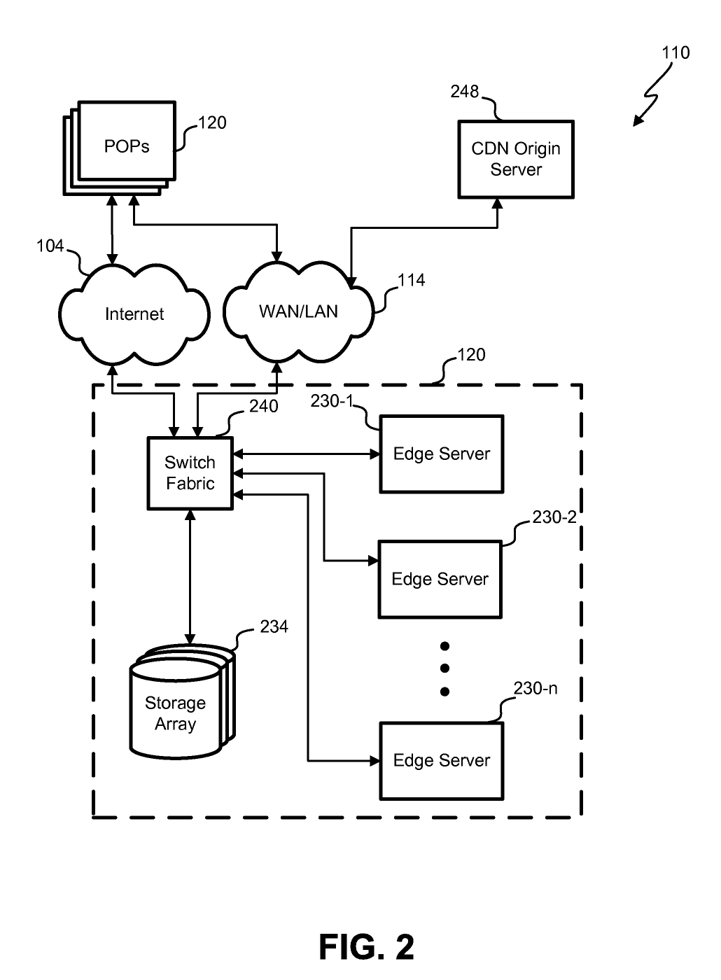

With reference to FIG. 2, a block diagram of an embodiment of a CDN 110 is shown. Although only one POP 120 is shown in detail, there are a number of POPs 120 similarly configured throughout the CDN 110. The POPs 120 communicate through a WAN/LAN 114 and/or the Internet 104 when locating content objects. An interface from the Internet 104 to the POP 120 accepts requests for content objects from end-user systems 102. The requests come from an Internet protocol (IP) address of the end-user system 102 in the form of a URI that causes an HTTP get command. The requests for content files from the CDN 110 pass through the application layer.

Switch fabric 240 assigns the request to one of the edge servers 230 according to a routing scheme such as round robin, load balancing, etc. In some embodiments, the switch fabric 240 is aware of which edge servers 230 have what capabilities and assigns requests within the group having the capability to store and serve the particular content object referenced in the URI. Edge servers 230 gathered in a particular group as neighbors can be grouped with other servers in the current POP 120, less loaded servers in the current POP 120, servers having a capability to process the content object, a subset of servers assigned to a customer using the CDN 110 to serve the content object, or some other grouping of servers in the POP 120.

In some cases, the CDN 110 is used to host content for others. Content providers 108 upload content to a CDN origin server 248. Although only one CDN origin server 248 is shown, it is to be understood that there could be many spread among a number of locations and/or POPs 120. The content object can be stored in the CDN origin server 248. The CDN origin server 248 serves the content object within the CDN 110 to various edge servers 230 in various POPs 120. After the content provider 108 places a content object on the CDN origin server 248 the content object need not be hosted on an origin server 112 of the content originator 106 redundantly. Although shown separately, it is to be understood that the CDN origin sever 248 could be integral to an edge server 230.

Some embodiments include an optional storage array 234 in the POP 120 or elsewhere in the CDN 110. The storage array 234 can provide hosting, storage, and/or caching. Edge servers 230 can revert to the storage array 234 for certain content, for example, very large files or infrequently requested files. Flushing of a cache of an edge server 230 could move the content to the storage array 234 until it is ultimately flushed from the storage array 234 after which subsequent requests would be fulfilled by an origin server 112 to repopulate cache in the POP 120.

Requests from end-user systems 102 are assigned to an edge server 230 that may cache, store, or host the requested content object. At times, the edge server 230 receiving a request does not have the content object stored for immediate serving. This so-called “cache miss” triggers a process within the CDN 110 to find the content object (or portion thereof). The content may be found in neighboring edge servers 230 in the same POP 120, in another POP 120, in a CDN origin server 248, in a POP storage array 234, or even an origin server 112 external to the CDN 110. The various edge servers 230 and CDN origin servers 248 are grouped for various URIs uniquely. In other words, one URI may look to one group of servers 230, 248 on a cache miss while another URI will look to a different group of servers 230, 248.

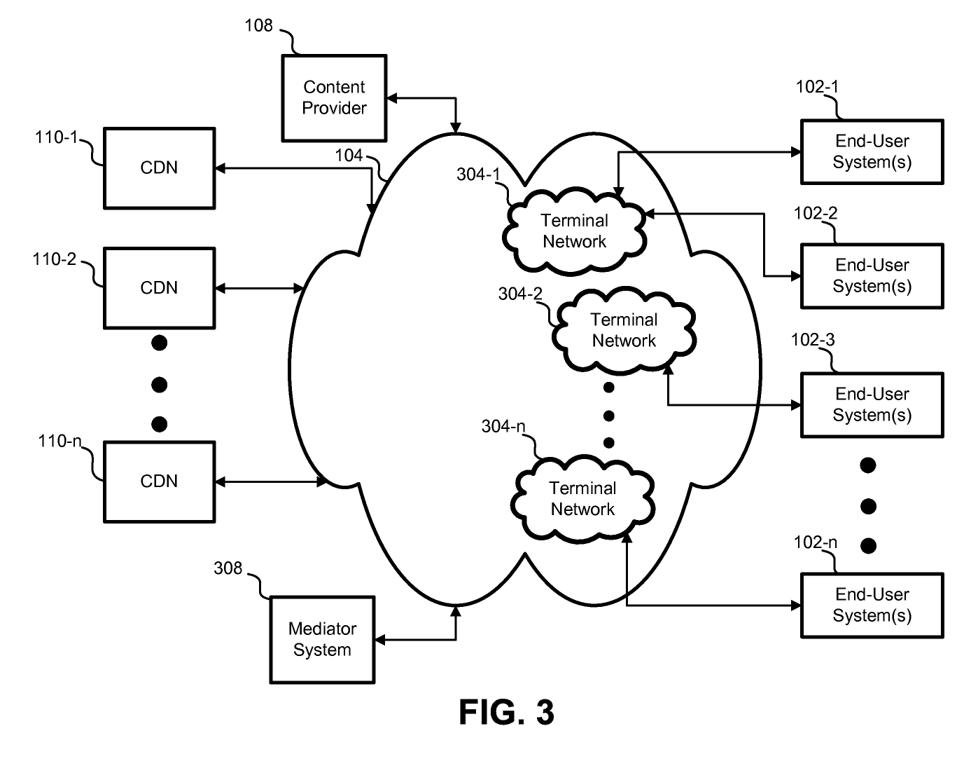

Referring next to FIG. 3, an embodiment of a cooperative delivery system is shown. A content provider 108 is connected to the Internet 104. Also connected to the Internet 104 are a plurality of CDNs 110 and a plurality of end-user systems 102. As part of the Internet 104, a plurality of terminal networks 304 provide internet service to the plurality of end-user systems 102. In some embodiments, terminal networks 304 are “last mile” networks providing telecommunications, cable television, and/or Internet services to end users 128. Some examples of terminal networks 304 include CenturyLink, Comcast, Verizon, and AT&T. In some embodiments, terminal networks 304 include peer networks. In some embodiments, terminal networks 304 have caches to store content objects. Caches of the terminal networks 304 can be a single cache, or spread out among a plurality of caches similar to a CDN 110 with a plurality of POPs 120. Some terminal networks 304 function as a content delivery network 110.

In this embodiment, the content provider 108 contracts with a first CDN 110-1 for delivery of a content object to end-user systems 102. Though only one content provider 108 is shown, there may be many content providers 108 contracting with CDNs 110 and/or terminal networks 304 for delivery of a plurality of content objects. Also, an origin server 112 having the content object can be external to the CDN 110 or internal to the CDN 110, such as in a CDN origin server 248. In some embodiments, the first CDN 110-1 subcontracts delivery of the content object to a second CDN 110-2 and/or terminal network 304 for delivery to an end-user system 102. The first CDN 110-1 may subcontract delivery of the content object for various reasons. For example, the second CDN 110-2 may have a better coverage of POPs 120 in a given geographic area. The first CDN 110-1 may have several POPs 120 in North America and Europe, but not South America. The second CDN 110-2 may have several POPs 120 in South America. To deliver the content object to an end user 128 in South America, the first CDN 110-1 subcontracts delivery of the content object to the second CDN 110-2. In another example, the second CDN 110-2 also has POPs 120 in Europe. When POPs 120 of the first CDN 110-1 in Europe become overloaded, the first CDN 110-1 has the second CDN 110-2 deliver the content object in Europe.

In some embodiments, the first CDN 110-1 subcontracts delivery of the content object with terminal networks 304. For example, the first terminal network 304-1 caches the content object when delivering the content object to a first end-user system 102-1. When a second end-user system 102-2 requests the content object, the first terminal network 304-1 serves the content object from a cache of the first terminal network 304-1.

In some embodiments, a mediator system 308 is also connected to the Internet 104. The mediator system 308 serves several functions for the cooperative delivery system, such as assignment, accounting, and control. In some embodiments, the mediator system 308 receives requests for delivery of the content object and assigns a CDN 110 or a terminal network 304 to deliver the content object. The mediator system 308 chooses a CDN 110 or terminal network 304 based on geography, latency in a network, delivery cost, quality of service, etc. In some embodiments, the mediator system 308 contracts with the content provider 108 for delivery of the content object instead of the first CDN 110-1 contracting with the content provider 108 for delivery of the content object. In some embodiments, the mediator system 308 is part of, and/or controlled by, a CDN 110 or terminal network 304. Also, a cooperative delivery system may comprise two or more mediator systems 308, and each mediator systems 308 is tied to a particular CDN 110.

In some embodiments, the mediator system 308 accounts for content delivery. After assigning delivery of the content object to a CDN 110 or terminal network 304, the mediator system 308 credits that network with delivery of the content object. In other embodiments, the mediator system 308 receives reports about delivery of the content object before crediting the CDN 110 or terminal network 304 for delivery.

In some embodiments, the mediator system 308 also establishes control parameters for delivery of the content object. For example, the content provider 108 sets a minimum quality of service threshold for delivering the content object. When assigning delivery of the content object, the mediator system 308 passes variables specifying the control parameters to the CDN 110 and/or terminal network 304 delivering the content object.

### Dynamic Content Transformation by Device Type

Embodiments described herein provide for securely storing policy-managed content objects in a content storage network utilizing a client portal. According to various embodiments, a client portal operating on a client device can accept a selection of a content object and an assignment of one or more policies that are configured to govern the way the content object is stored and/or uploaded to a content storage network. The client portal can operate as a virtual file server to provide virtualized access to files stored within the content storage network. The client portal can provide real-time feedback indicating how the one or more policies are currently being applied to the content and whether or not the content objects comply with the policies. Additionally, the client portal may provide transparent encryption such that content objects are stored in the content storage network in an encrypted form that is only able to be decrypted at the client portal. Block-based encryption techniques can be employed such that portions of the content object can be decrypted in order to provide a preview for customers that browse the contents of the content storage network from the client portal.

In recent years, content delivery networks (CDNs) have been used to deliver content for content providers to a large number of customers. As described above, CDNs include a plurality of points of presence (POPs) that are geographically distributed throughout the world. Each POP can include tens or hundreds of edge servers that cache content deliverable to end-user systems. While any type of content can be distributed using a CDN, they are particularly effective for providing streaming media, such as movies, music, and/or the like.

In contrast, cloud storage networks are generally used by customers to store information remotely in order to safely archive data and collaborate among multiple users. For example, individual users may use cloud storage to archive home movies and photos and share these files amongst their friends and family. Businesses may use cloud storage to provide a central repository for critical data that may need to be shared between development groups for different divisions in different geographic locations. Most cloud storage solutions are implemented very simply, and provide users only with the ability to upload, download, and browse the contents of their particular storage library.

The embodiments described herein combine the advantages of an existing CDN with the concept of cloud storage. As used herein, the term “content storage network” may broadly referred to any storage network accessible over a network connection such that users can archive, store, browse, manipulate, and/or share data on devices. For example, the content storage network may include a traditional cloud storage network. However, in other embodiments a content storage network may refer explicitly to a CDN that offers both content delivery services as well as cloud storage services.

Numerous advantages may be realized by combining the hardware and footprint of an existing CDN with the options available for cloud storage. First, an existing infrastructure of edge servers may be utilized to locate copies of uploaded content close to customer-proximate locations. For example, a business with locations in China, the United States, and London may upload content from the United States that will be accessed primarily in China. The way in which the content storage network stores and manages the upload content can be defined through the use of policies. Policies can control the number of copies, the location of copies, the format and availability of copies, and/or the like. For example, although uploaded in the United States, the content storage network may store copies in POPs located in regions of China in order to provide efficient upload and download for nearby customers. Using a CDN as a content storage network also allows customers to govern how their content is stored rather than leaving this decision up to the content storage network exclusively. Customer storage footprints can also grow exponentially as needed and content can be proliferated throughout the resources available to the CDN. None of the services are currently available using traditional cloud storage networks. Likewise, traditional CDNs have not previously offered a method for customers to securely store content therein as a content storage network rather than a content distribution network.

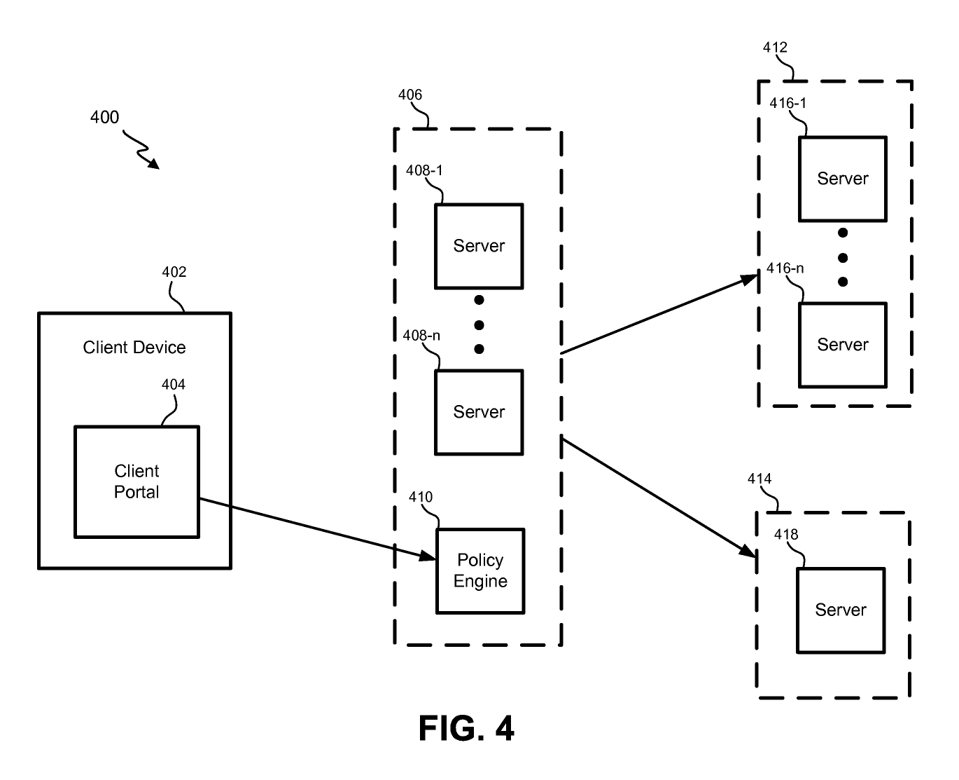

FIG. 4 illustrates a block diagram 400 of a system for securely managing policy-based content uploads and storage, according to some embodiments. As described above, the system includes a content storage network, which in an exemplary embodiment may be implemented using a traditional CDN infrastructure with the resources therein configured to operate as a cloud storage network for particular customers. As described above for a CDN, the content storage network may include a plurality of geographic locations 406, 412, 414. Each of the plurality of geographic locations 406, 412, 414, may include a plurality of servers 408, 416, 418, respectively. For, example, the content storage network may include a plurality of geographically distributed POPs, each of which includes a plurality of edge servers. Each of the servers located in different geographic regions may be configured to communicate with each other over a network such as the Internet.

A client portal 404 may act as an access point for a customer to upload, view, manipulate, and share data stored in the content storage network. The client portal 404 may include a software process configured to be deployed to a client device 402 and operated thereon. For example, the content storage network may provide proprietary software that can be downloaded or distributed to client devices when they sign up for a cloud storage service provided by the CDN. Using the client portal 404, customers can upload data to the content storage network. As will be discussed further below, the client portal 404 may also be used to assign, define, and/or select one or more policies to govern content uploads and storage. In these embodiments, the client portal 404 may be communicatively coupled periodically to a policy engine 410. As a content objects are uploaded to the content storage network, the policy engine 410 can analyze the content object and the one or more assigned policies and control storage and distribution of the content object accordingly.

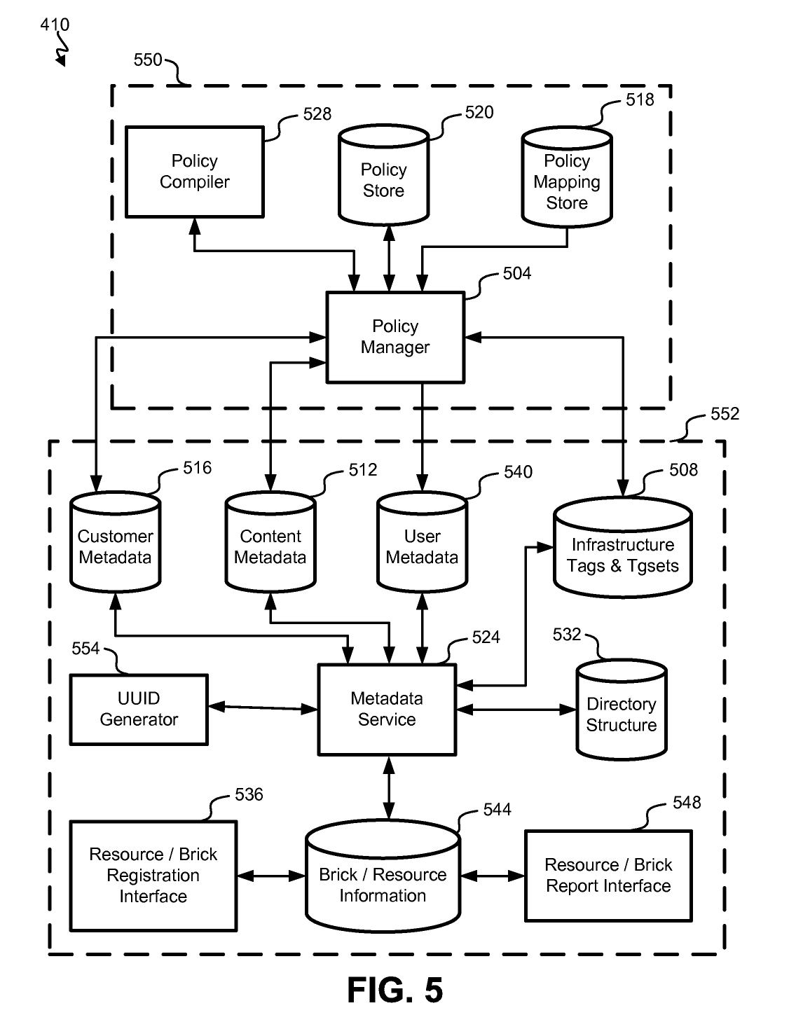

FIG. 5 illustrates a block diagram 500 of a policy engine 410, according to some embodiments. The policy engine 410 may include a policy reconciliation service (PRS) 550 interacting with a metadata directory 552. The PRS 550 may include a policy manager 504 that controls a policy compiler 528, a policy store 520, and a policy mapping store 518. The policy compiler 528 may perform disambiguation to resolve conflicts when multiple policies apply to the same content object. Conflicts can be resolved by a hierarchical scheme where policies higher in the hierarchy take precedence. In another embodiment, the policy compiler 528 can choose the most or least stringent of the conflicting policies. For example, a policy that requires all JPEG files be deleted after two weeks and another policy that requires all files to be deleted when not requested for a day could be resolved either most stringently to delete the JPEG file after not being used for a day or least stringently to be deleted after two weeks. Additionally, any syntax errors in the policies can be found and identified by the policy compiler 528.

The policy store 520 can store all the policies applicable to a particular customer, a particular content type, and/or the entire content storage network. The policies may be applicable to many customers, and each customer may have various types/levels of alterations for a particular customer. There are policies for ingest, replication, hosting, transcoding, encryption, compression, thumbnailing, workflow generation/execution, aging content in/out of system, and other processing for a content object. Each policy may be a function with defined PRS parameters that include criteria, variables, storage disposition and optional mutators. Table I below shows examples of some policies with the PRS parameters that implement the policy and the variables used. For example, a transcode policy can retrieve a source URL and places it in an intake subdirectory for the transcoder. The transcoder performs any number of different transcodes on the source files as specified and stores the resulting files as the specified transcode URLs.

TABLE I
Example Ingest and Hosting Policies

| Policy | PRS Parameters | Variable(s) |
|---|---|---|
| Ingest | Ingest API | Origin URL, Content Tags, |
| | Information | Transcode Options, |
| | | Storage Options, Purge Date |
| | Transcoder | Transcode Options, URL, |
| | Format(s) | Content Tags |
| | Store File(s) | File Name, Storage Options |
| | Automatic Purging | Purge Date |
| Replication | File Copy | Number of Copies, Content |
| | | Tags, Infrastructure Tags |
| Transcode | Retrieve Source | Source URL |
| | n Transcodes | Transcode Options, Different |
| | | Transcodes, Source URL, Content |
| | | Tags |
| | Store Results | Transcode URLs |
| Host | Hosting API | Origin URL, Content Metadata, |
| | Information | Customer Metadata, |
| | | Storage Options, Purge Date |
| | Store File(s) | Stored URL, Storage Options |
| | File Aging | Purge Date |

Policies can be preformulated or custom designed by content providers, content receivers, and/or administrators of the content storage network. A policy could be represented in any format (e.g., XML, text, etc.) and can include command line instructions, run-time executed source code, or compiled object code. Policies can age into or out of the system. In one embodiment, a PRS parameter can act as an instruction in a CDN-specific programming language. A policy can be assigned to an end user who receives content, a customer who provides content, a content object, a class of content objects, a directory, and/or any other tag or metadata demarcation.

Criteria for a policy define its applicability to the content objects in the content storage network. Criteria allow size-based processing, MIME type workflows, or any metadata or tag qualifier before performing the policy. For example, a compression policy could be applied to a particular MIME type stored in a particular POP that has not been requested for some period of time.

Each policy has PRS parameter that defines a disposition for the content object to be performed after any processing. The disposition can say what type bricks 130 or resources 134 to use. The number of copies of the content object to have and what geographic spread to place on those copies can also be defined. A deletion date can be defined in the PRS parameter.

A content mutator indicates a resource that can be instructed to process the content object. An application programming interface (API) presented by the resource typically includes a source path and a filename for the content object, along with any number of variables that can affect processing by the resource 134. The content mutators may be addressed or represented by a URL in this embodiment, but other embodiments could use any format. The content mutator URL identifies the address of the resource, a source content object location that is being operated upon, and a number of variables. The conent mutator URL can perform conditional actions based upon prior content mutators and/or variables.

The functionality of a policy is demonstrated with an example thumbnailing policy that uses a thumbnailing resource to create thumbnail images for an image content object. In this example, the policy can store any files which end in the file name extension is ‘jpg’ in three different locations. One of the locations is in the European Union and two are stored in the United States. Once all copies have been made, a call to the thumbnailer resource can be made, which generates a small thumbnail image of the source JPEG file that is stored in a predetermined location. The thumbnailer resource can use the pathname of the source JPEG file as well as its size in bytes passed as variables in the content mutator URL. The thumbnailer resource 134 can be an HTTP-based API which is called with a URL, such as: http://www.imagetransform.org/thumbnailer?path=<full path to source image>&size=<size of image>. In this case, the resource is located at the address of the “imagetransform.org” domain, which may or may not be within the content storage network.

In this example, all known storage locations in the content storage network have infrastructure tags 508 for their geographical locations (e.g., city, metropolitan area, country, supranational entity). For example, a storage locations in London would be tagged with the tags LONDON, UK, EU, and EMEA. A storage locations in Paris would be tagged with PARIS, FRANCE, EU, and EMEA. A storage locations in Chicago would be tagged CHICAGO, IL, USA, NA, and AMERICAS, and so forth.

One or more tag data structures 508 hold the infrastructure tags and tagsets along with addresses of all storage locations or resources that comply with each tag or tagset. The tagset could be named to be the same as the tag, by convention (i.e. LONDON, USA, etc). Tagsets could be conjunctions of two or more tags. For example, a tagset called LOND-HPERF could contain both the LONDON and HIGH-PERFORMANCE tags. A query to the metadata service 524 for a given tag or tagset would return all storage locations and resources that are associated with the queried tag(s).

All known storage locations or resources can be arbitrarily grouped in a tagset having any number of tags. For geographic tags, a storage location cannot be in London and somewhere else at the same time, so generally a geographic tag is not conjoined with other geographic tags in a tagset. Not all the tags which exist need to be in a tagset; some might be reserved for future use. Similarly, not all tagsets need be utilized in any policy.

An example policy is expressed in a pseudo language below utilizing four PRS parameters. The first PRS parameter is the policy name. For the second PRS parameter, one or more criteria can be specified as positive or negative logic tests for a precondition to be fulfilled before applying the policy. In this example, the criteria define applicability to content files of the JPG MIME type. The disposition in the third PRS parameter includes the storage conditions specifying tags and the minimum number of copies.

Policy: “ExamplePol”

Criteria: [{name=‘.*.jpg$’}]

Disposition: [{Tagset=“USA”, MinBricks=2}, {Tagset=“EU”, MinBricks=1}]

Thumbnail Mutator=[http://www.imagetransform.org/thumbnailer?path=% p&size=%s]

In order to decide the applicability of this policy, the PRS 550 would first would look at the name extension of the file as a criteria. If it matches the regular expression ‘.*.jpg$’ (that is, it ends with the text ‘jpg’), then this policy applies. Any other files would not be deemed to be covered by this policy.

When executing the policy, the PRS 550 would select two storage locations (or “bricks”) that have all the tags in the tagset USA, and one storage location from the set which have all the tags in tagset EU. The storage locations could be chosen by any criteria, including random selection, round robin, available space, cost of storage, proximity in network terms, bandwidth cost to transport the file, etc. Once three receipts come back from those storage locations marked COMPLETE, the source JPEG file itself goes into the COMPLETE state, and the thumbnail mutator in the PRS parameter list gets called, substituting the metavariables “%p” with the full path to the object, and “%s” with the size in bytes of the image object. Other policies could have any number of mutators for storage, transcoding, replication, or other processing for a content object as described above.

The policy mapping store 518 records which policies are mapped to various levels of the hierarchy. Various embodiments could map policies to the national jurisdiction, regional jurisdiction, storage-network-wide, POP-applicable, customer, sub-customer, directory, sub-directory, MIME-type, individual file, and so forth, to achieve any level of granularity. As described above, policies can be organized into hierarchies to determine how they are applied. The policies for a particular level can be organized according to priorities determined for other policies at that level. Policies in a higher block can take precedence over those in a lower block during the disambiguation processes performed by the policy compiler 528. Some one-time-use policies may disassociate themselves with a particular level of the hierarchy once performed. For example, a policy could be used to update coding on the content library from a legacy format where all new content is received in the updated coding. After running the policy once, it can be disassociated from the customer with a PRS parameter in the policy that removes the association in the policy mapping store 518.

A directory structure 532 can provide each customer has a directory with optional subdirectories. Each directory or subdirectory can hold file names for content objects submitted by the customer. The directory structure 532 is stored in the metadata directory 552 in this embodiment. Table II shows an example of a portion of the policy mapping 518 for an exemplary hierarchy and directory structure. The “ZBS_Radio” client has subdirectories for “streams” and “podcasts.” All the files in the “/ZBS_Radio/streams” path have both ingest and host policies that are applied, while all the files in the “/ZBS_Radio/podcasts” path have ingest, transcode and host policies that are applied.

TABLE II
Policy Mapping

| Directory | Subdirectory | File | Policy |
|---|---|---|---|
| ABS Movie | — | — | Ingest, Replication, |
| Channel | | | Host |
| . . . | . . . | . . . | . . . |
| ZBS Radio | Streams | — | Ingest, Host |
| | Podcasts | — | Ingest, Transcode, |
| | | | Host |
| Realure | — | Silverthorne | Ingest, Replication |
| eBooks | | Trails.epub | |
| | | Keystone | Ingest, Replication |
| | | Boarding.epub | |
| | | Aventneer.epub | Ingest |
| | | Aventneer | Ingest, Replication, |
| | | Audio.mp3 | Transcode |

A UUID generator 554 can assign a 256 bit code to each path and filename stored in the content storage network. The UUID becomes the file name for content objects stored with the various storage locations. The UUID is a one-way function in that the path and file name cannot be determined from the UUID alone, but a query to lookup decoder can return the storage locations storing a particular UUID and the path and file name.

The metadata directory 552 maintains metadata, tags and tagsets that are used by the policies to process content objects. There is customer metadata 516 describing details about the customer. The customer metadata 516 is entered when the customer configures their account with the content storage network and includes at profile holding personal information, account information, any sub-account(s), zone, channel, confidentiality level, and/or the like. The directory and subdirectory structure for a customer is stored in the directory structure 532 in this embodiment, but could be stored with other customer metadata 516 in other embodiments.

Also stored is user metadata 540 that is discerned by the content storage network about the end user. Typically, the end user does not intentionally interface with the content storage network, so the user metadata 540 is largely discerned indirectly. Metadata includes usage habits, content preferences, demographic information, user identifiers, POP location receiving requests, and/or end user system locations. A content player, an IP address, cookies, or other techniques may be used to discern one user from another. Privacy concerns can limit the availability of user metadata 540.

Infrastructure tags and tagsets are assigned to storage locations and/or resources. The number of tags may increase as customers want greater granularity in applying policies. Infrastructure tags may include: carbon use, energy use, storage type (e.g., solid state, magnetic, optical, spinning, tape), equipment manufacturer, reliability (e.g., dual-location replication, RAID level, tape archive), write-only, write-once, interface speed (e.g., SATA, SAS, Ethernet, 10 Gb), retrieval latency, storage cost, physical security surrounding equipment, geographical location of content, various performance discriminators, equipment location to city, region, or country, POP, IPV4 or IPV6 compatibility, CDN hosted, user hosted, level of QoS, and/or the like. The tags can be applied to storage locations and resources regardless of whether they are inside or outside the CDN 110.

Content metadata 512 relates to content objects with the CMA. The content metadata 512 can additionally be stored in the content object itself and/or its file name. The content metadata includes MIME type, encoding, container format, copyright terms, cost terms, copyright year, actors, director, studio, program summary, content rating, critical review ranking, title, transcript, ad insertion locations, encryption, request popularity, etc. Some content metadata 512 is not stored in the database or store, but is discerned through interaction with the content file. For example, MIME type is readily discernible from the file itself without refereeing the content metadata 512 in the store or database.

Storage locations (bricks) and resources can be expressly enrolled to work with the content storage network. A registration interface 536 is used to enter the address or domain name for the brick or resource that is stored in a brick/resource information store 544. The bricks and resources can periodically report health and status information through a report interface 548 that is also stored in the brick/resource information store 544. The metadata directory 552 can periodically request status and health information using the report interface 548 or can test the brick or resource. Where calls to the brick or resource fail or perform poorly, the brick/resource information 544 can be updated to reflect status.

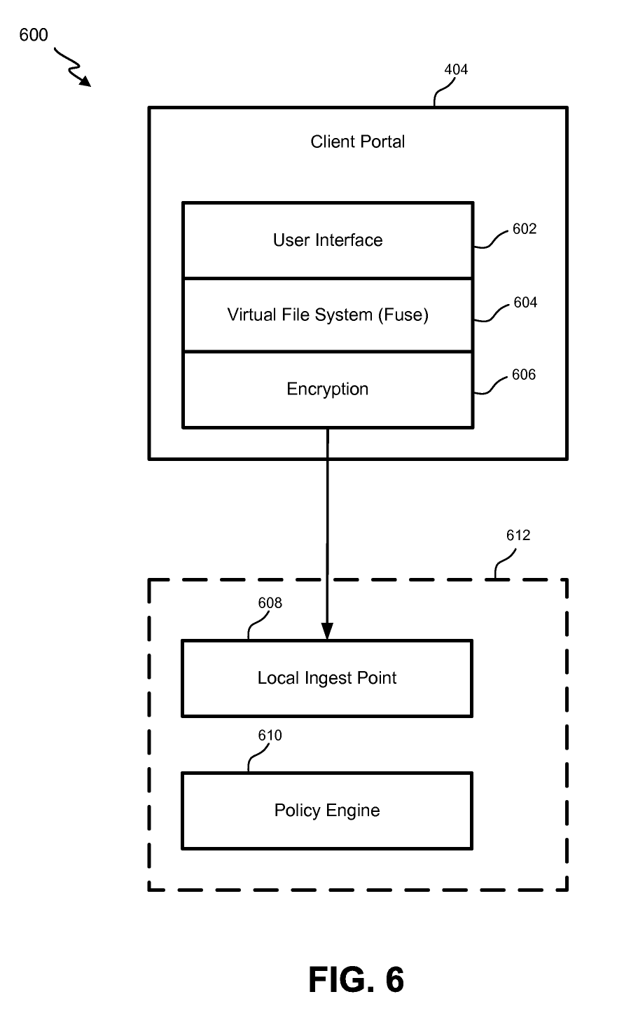

FIG. 6 illustrates a block diagram 600 of a client portal 404, according to some embodiments. The client portal 404 may include a user interface 602 configured to allow users on a client device to manage, browse, upload, and share content objects that are stored by the content storage network. The user interface 602 may be implemented in a web browser and operate in a client-server relationship with the content storage network. In other embodiments, the user interface 602 may be implemented as a mobile app for a client device such as a smart phone or tablet computer. The user interface 602 may also be implemented as a stand-alone application on a desktop workstation or PC. Exemplary embodiments of the user interface 602 will be described below.

The client portal 404 may also include a virtual file system 604, such as a “Fuse” file system implemented in user space. The virtual file system 604 may be implemented locally on the client device such that it appears to a user as a local drive or directory. The virtual file system 604 may provide virtualized access to all the content stored in the content storage network that is associated with a particular customer account. The virtual file system 604 may receive content requests from the kernel of the local operating system and return content objects received from the content storage network.

The client portal 404 may also include an encryption layer 606. Because some embodiments may utilize the infrastructure of a CDN to implement the content storage network, content stored by a particular user may be stored on physical drives that also include information stored by other users. In order to provide secure content storage, the content storage network may partition the physical storage drives, govern access based on user privileges, and/or store content objects in an encrypted format. The encryption layer 606 may be appointed as part of the client portal 404 such that content object encryption/decryption appears to be transparent at the client device.

In some embodiments, the encryption layer 606 of the client portal 404 can receive content objects to be uploaded through the user interface 602 and/or the virtual file system 604 and encrypt the content objects before providing objects to a local POP 612 of the content storage network. The encryption keys used to encrypt/decrypt the content object may be stored locally at the client portal 404 such that the content storage network is unable to decrypt any proprietary information stored by customers. Alternatively, the client portal 404 can store a private key for decryption and data can be encrypted using a public key by either the client portal 404 or the content storage network. Therefore, a security breach at the content storage network could compromise the encrypted information only if each operating client portal were similarly compromised. By storing decryption keys separately from the encrypted content, the security of such information can be enhanced.

Encrypted information can be received by a local ingest point 608 of the POP 612. The local ingest point 608 may be implemented using a landing pad configured to receive upload content for the content storage network. This can be thought of separately from an origin server used to upload content to a CDN to be cached in edge servers for widespread content distribution. As described above, content objects received by a local ingest point 608 may include one or more policy selections or definitions that can be analyzed and implemented using a policy engine 610.

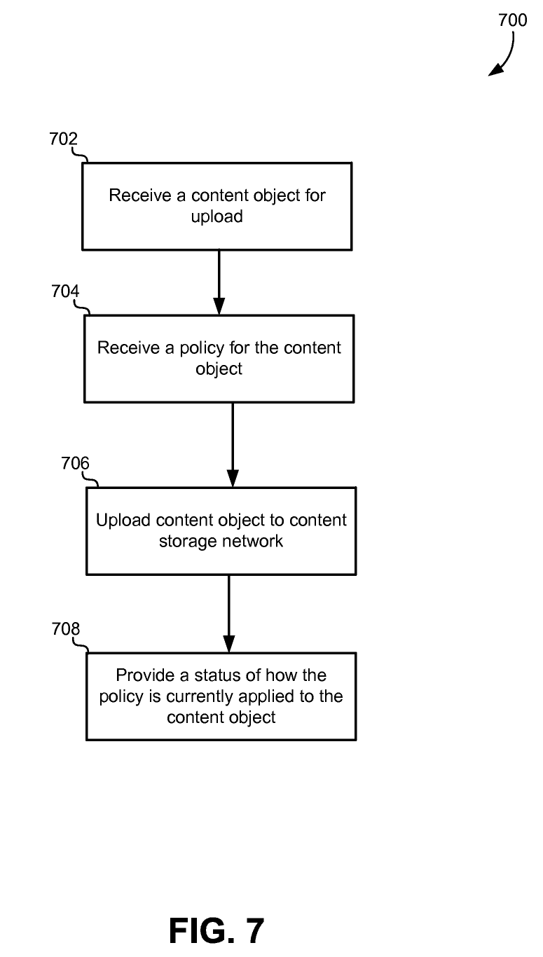

FIG. 7 illustrates a flowchart 700 of a method for securely managing policy-based content uploads and storage, according to some embodiments. The method may include receiving a content object for upload (702). The content object may be received by a client portal that is configured to be deployed to a client device and operated thereon. Content objects may be received singly, and/or a group or class of content object may be identified in a local storage device. For example, a client portal can receive an input instructing the client portal to upload all JPEG files that have been modified in the past week. The content object may include any type of digital content, such as movies, music files, PDFs, white papers, HTML files, and/or the like.

The method may also include receiving a policy for the content object (704). The policy may be one of a plurality of policies received for the content object. The policy may be selected from amongst a plurality of predefined policies, or the policy may be defined by a user through the client portal. A single policy may be assigned to a plurality of content objects selected for upload. Policies may be assigned to classes of objects and may govern a characteristic of how the content objects are stored, viewed, manipulated, and/or shared on the content storage network. As described above, policies may govern storage locations, numbers of copies, encryption schemes, transcodings, partial object distributions, and/or the like. The client portal can be configured to receive inputs from a user that define the elements of policy.

The method may additionally include uploading the content object to the content storage network (706). The policy may govern when and how the content object is uploaded. The upload may commence immediately and continue without interruption. Alternatively or additionally, the upload may be scheduled at a later time to take advantage of off-peak pricing. In some cases, the content object can be loaded in chunks at different times. For example, the first 5 minutes of video may be uploaded first such that other users can view what may be considered the most popular portion of the video, while the remaining video portion may be uploaded at a later time. As described in greater detail below, uploading the content object may involve transparently encrypting the content object at the client portal such that it is stored in an encrypted form in the content storage network.

The method may further include providing a status of how the policy is currently being applied to the content object (708). Various factors such as network traffic, bandwidth, storage congestion, customer preferences, and/or content storage network preferences may affect how each policy is applied to a content object as it is uploaded and stored in the content storage network. For example, if a policy dictates that a content object should be stored in multiple geographic locations around the world, distribution the content object may be affected by content storage network usage and bandwidth limitations. Therefore, after uploading a content object, it may take some time in order to fully conform to the elements of the policy.

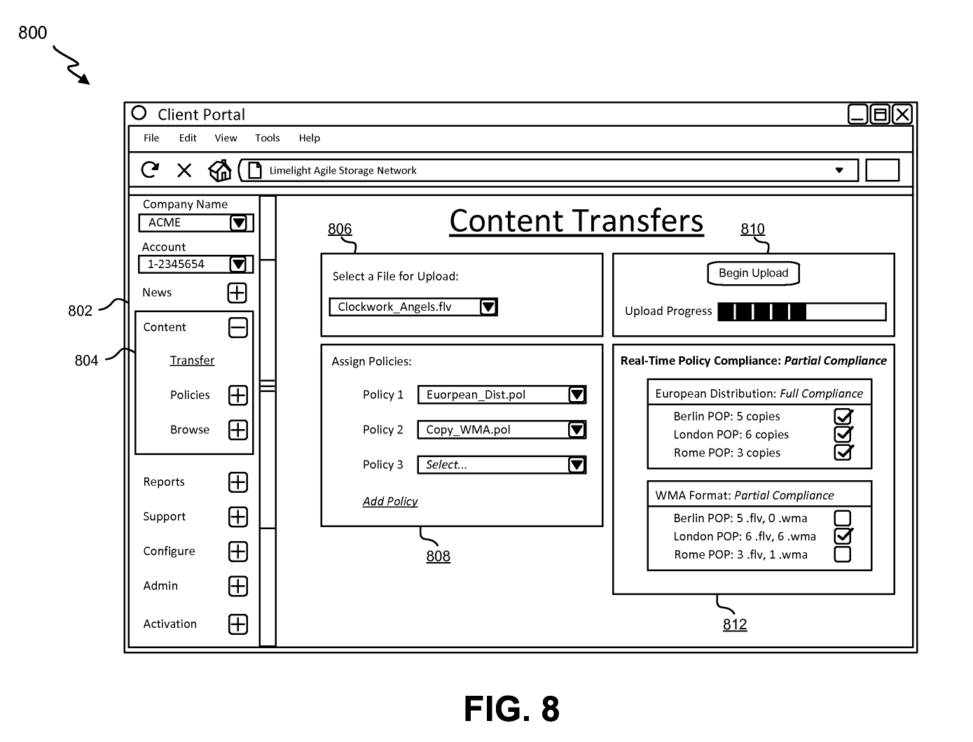

The client portal may include one or more indications that indicate the extent to which uploaded content conforms to the assigned policies, predictions as to when the content will fully conform to said policies, along with progress indicators and/or the like. In order to illustrate how policy progress and status can be indicated, an exemplary user interface for the client portal will be described. FIG. 8 illustrates an interface 800 that may be presented by the client portal, according to some embodiments. The client portal may include a menu 802 that allows customers to login and provides a options to view/manipulate their secure content. The menu 802 may include options to generate reports, to contact customer service, to configure user preferences, to activate various services and features, to receive news and updates from the content storage network, and/or the like.

Additionally, the menu 802 may include options for manipulating, transferring, viewing, and/or sharing content in a content menu 804. The content menu 804 may present one or more user interface displays, each of which allows the customer to perform specific actions related to their content objects. By way of example, the content menu 804 illustrated in FIG. 8 presents a display for content transfers, such as uploading content from a client device to the content storage network. The display may include a content object area 806 for selecting one or more content objects for upload. The display may also include a policy area 808 for selecting or defining policies to assign to the selected content object(s). The policies can be stored and/or created locally on the client device. Alternatively, the policies can be defined, stored, and/or managed by the content delivery network and exposed to the client portal. Although not shown explicitly, by selecting to add a new policy, a customer can define elements of the policy (e.g. number of copies, location copies, encryption, etc.) and combine these elements using logical operators (e.g. “encrypt using AES 256 if stored in China”).

The display may also include an upload status area 810. The upload status area 810 may include a progress bar or other graphical indicator to show the status of the content upload. In some embodiments, the upload status area 810 may also indicate an estimated time until the upload is complete, an estimated upload schedule when uploading is delayed for off-peak delivery, and/or a summary of operations that may take place associated with the upload, such as transcoding, encryption, chunking and/or the like.

The display may also include a policy status area 812 that is configured to indicate the compliance status for each policy assigned to the content object. In this particular example, a policy that governs content distribution to storage locations in Europe has been assigned to the content object, as well as a policy that governs transcoding into a WMA format. It will be understood that these policies are merely exemplary and not meant to be limiting. Many other policies such as those described herein may be used as well.

The policy status area 812 may indicate an overall compliance level (e.g. noncompliance, partial compliance, full compliance, a compliance percentage, etc.) for any and/or all of the policies assigned to the particular content object or class of content objects. Additionally, the policy status area 812 may indicate policy compliance levels for each individual policy. As illustrated in FIG. 8, the policy status area 812 includes a breakdown of policy compliance for both the European distribution policy as well as the WMA format policy. The breakdown for each policy can include a progress indication for each area of the policy. For example, the European distribution policy is in full compliance, as the requisite number of copies has been distributed to locations in Europe as defined by the European distribution policy. On the other hand, the WMA format is only in partial compliance as only a portion of the FLV files have been converted to WMA as specified by the WMA policy. Policy compliance can also be assessed for each geographic region or POP. Therefore, the WMA policy compliance indication may include statistics for each POP in the content storage network that should store a copy of the content object (e.g. London, Rome, etc.). Although not shown explicitly, the policy status area 812 may also include time estimates and/or schedules for when full policy compliance is expected or estimated to occur.

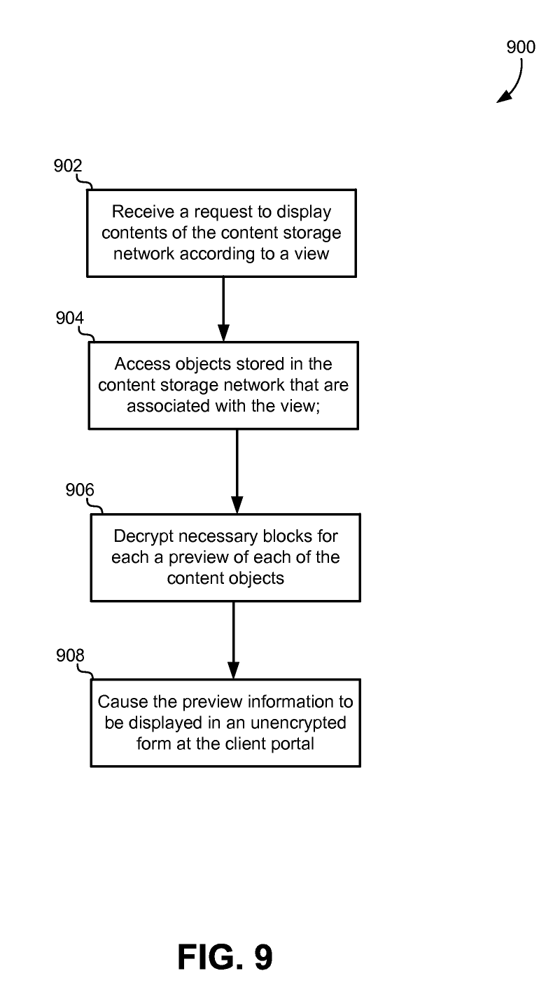

FIG. 9 illustrates a flowchart 900 of a method for securely providing content object previews in the client portal, according to some embodiments. As described above, content objects may be encrypted on-the-fly as they are uploaded and downloaded through the client portal. However, some embodiments of the client portal display contents of the content storage network in a manner that would be familiar to the customer when exploring the contents of any local drive. Thus, in order to look like a mounted local drive, the client portal can display preview information, such as icons, audio previews, video clips, content extracts, metadata, and/or other information that is descriptive of the content objects in directories assigned to the customer. This preview information will normally be stored in an encrypted form on the content storage network. Although some embodiments may store the preview information in an unencrypted form locally at the client device, this locally-stored preview information may become obsolete if the content objects are edited in another location in the content storage network. Other embodiments may download each file as their preview information is displayed by the client portal and decrypt entire file. However, this may add significant delay to the preview process. Therefore, some embodiments described herein may use block-based ciphers and decrypt only small portions of the files containing preview information for display in the client portal. If the customer wants to view the entire content object through the client portal, then the client portal can retrieve and decrypt the entire file for customer use.

The method may include receiving a request to display contents of the content storage network according to a view (902). As used herein, the view may refer to a content directory structure selection. For example, the view may include all of the content objects belonging to the customer. The view may alternately include the contents of a single folder or subdirectory in the customer's directory structure. The view may additionally include results of a search function or other filtering operation that selects content objects belonging to a customer according to different attributes or tags. For example, mounted virtual file structure of the client portal may be navigated by a customer in a manner similar to how a local file structure can be navigated.

The method may also include accessing objects stored in the content storage network that are associated with a view (904). The content storage network can retrieve a set of content objects implicated by the view (e.g. all content objects assigned to a logical subdirectory or meeting specific criteria). Note that this may include accessing content objects in local storage servers as well as storage servers that are remotely located depending on how the content objects are distributed in the content storage network according to assigned policies. For example, the view may access objects in a nearby POP as well as objects in more geographically remote POPS.

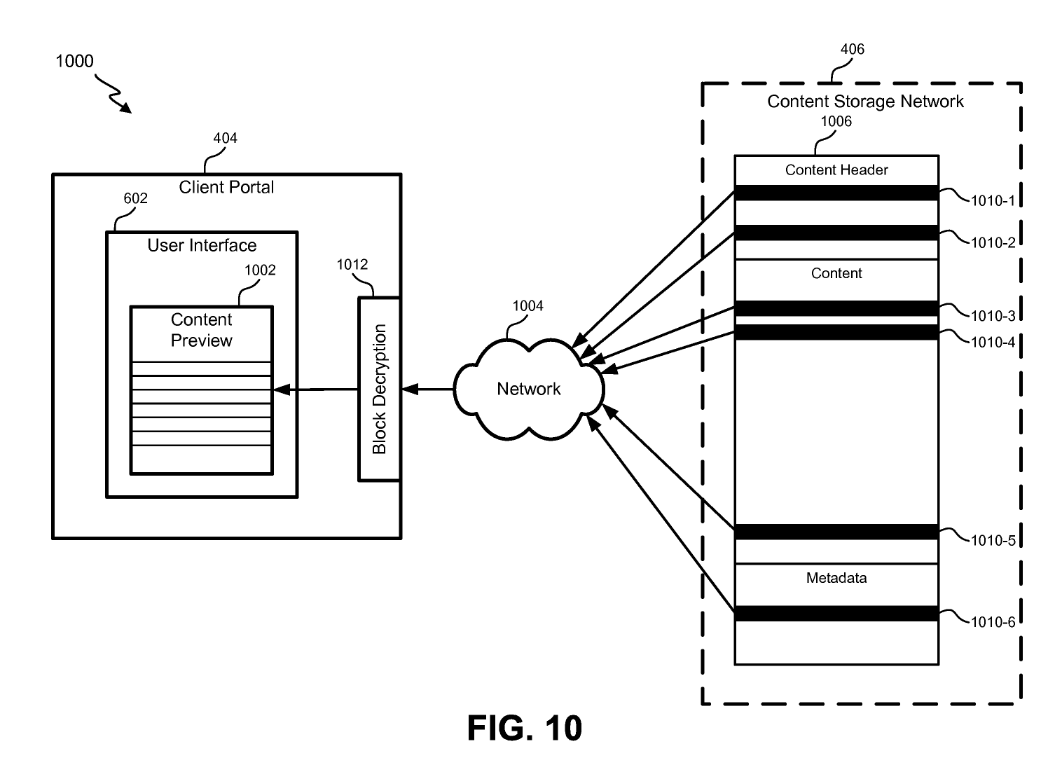

The method may additionally include decrypting necessary blocks for a preview of each of the content objects (906), and causing the preview information to be displayed in an unencrypted form at the client portal (908). By way of example, FIG. 10 illustrates a block diagram 1000 of a client portal 404 performing block decryption for content previews, according to some embodiments. The user interface 602 of the client portal 404 may display a content preview 1002 for a particular content object 1006 stored in the content storage network 406. In order to generate the content preview 1002, one or more preview blocks 1010 may need to be retrieved and decrypted from the content object 1006. The preview blocks 1010 may include defined portions of the content object that can be used to generate the content preview 1002.

In some embodiments, the content object 1006 may include multiple sections, such as a content header, a content body, metadata, and/or even a specific preview information section. The preview blocks 1010 may be retrieved from any and/or all of these sections. The preview blocks 1010 may be defined based on block sizes used in the block-based encryption algorithm. For example, 4 kB blocks may be used during the encryption process, and thus each of the preview blocks 1010 may also be sized at 4 kB. The client portal can retrieve the preview blocks 1010 through a network 1004, such as the Internet, and decrypt the preview blocks 1010 through a block decryption module 1012 in the encryption layer of the client portal 404.

In many cases, the size of the preview blocks 1010 will be such that additional information may be decrypted in addition to the preview information. The additional information may be discarded or saved locally. For example, preview block 1010-1 is from the content header portion may include preview information such as a file name, file size, and a modification date. However, preview block 1010-1 may also include additional information not needed for the content preview 1002. This additional information will necessarily be retrieved and decrypted with the rest of block 1010-1, and while the additional information need not be displayed as part of the content preview 1002, the client portal can save this additional information for when/if the entire content object 1006 needs to be retrieved and decrypted. This way, if the customer selects the content object 1006, only the remaining blocks that were not associated with the content preview 1002 need to be downloaded from the content storage network 406 and decrypted.

The selection of the preview blocks 1010 may be defined specifically for each particular content object 1006. For example, a customer or the content storage network may specify particular information that should be included in a content preview for each content object 1006 or each class of content objects, such as preview information for each JPEG file. In other embodiments, preview information may be generated dynamically by measuring the most popular or most requested portions of the content object 1006 and specifying these portions as part of the preview. For example, the first 15 seconds of video clip may be included in the preview information if it is determined that the first 15 seconds of the video clip are most often watched when the entire content object 1006 is downloaded and decrypted.

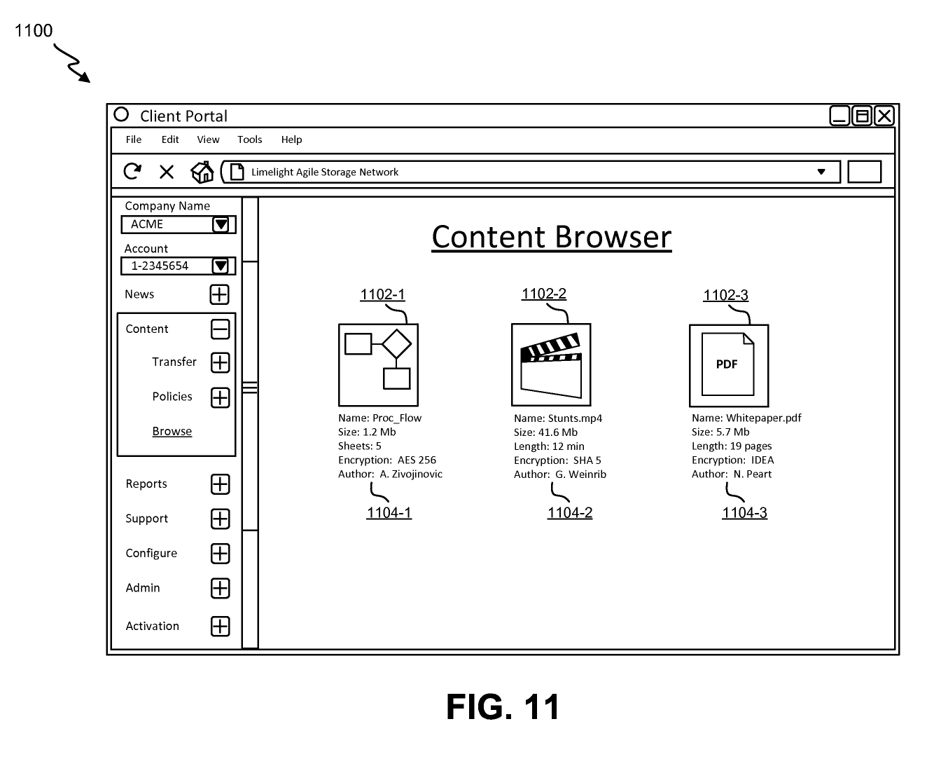

FIG. 11 illustrates an interface 1100 that may be presented by the client portal for securely providing content object previews, according to some embodiments. In this embodiment, the customer may select “Browse” from the content menu and navigate through a directory structure or other logical grouping to define a view for a content browser display. In this embodiment, the view may include three content objects 1102 and three previews 1104 may be generated. Note that at this point, only the preview information has been downloaded and decrypted at the client portal. The entirety of the three content objects 1002 is still stored in a decrypted from in the content storage network. By way of example, the previews 1104 include filenames, icons, file sizes, sheet numbers, clip lengths, page counts, encryption schemes, authors, and/or the like. If the customer selects one or more of the three content objects 1102, then the entirety of the three content objects 1102 can be downloaded and decrypted from the content storage network and displayed on the client device. In some embodiments, the blocks that were previously downloaded and decrypted to generate previews 1104 need not be downloaded/decrypted again.

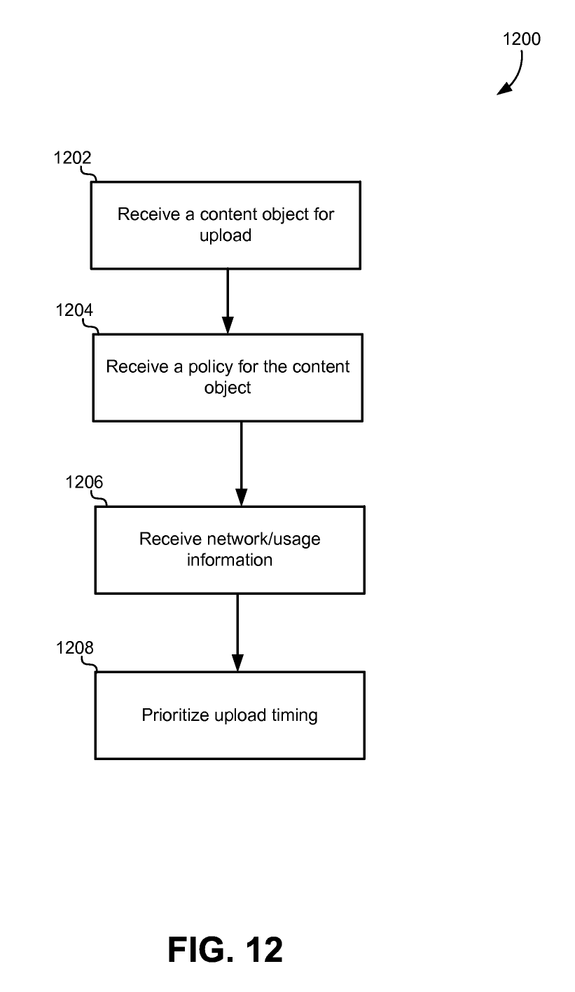

FIG. 12 illustrates a flowchart 1200 of a method for prioritizing upload timing, according to one embodiment. The method may include receiving a content object for upload (1202), and receiving a policy for the content object (1204). The policy may create some leeway for when the content object needs to be uploaded to the storage network. For example, the policy may allow the content object to be uploaded at any time within the next 12 hours. This may be particularly advantageous for files that are being updated or for files that are rarely used. At the landing pad, the system can make an extra backup copy of the content object that can be used to service requests to the local POP. The upload of the content object from the landing pad to the rest of the content storage network may be delayed until an efficient time for upload has been reached.

The method may further include receiving network/usage information (1206). This information may include traffic in the content storage network, and usage information of the particular content object. This information may also include usage information for similar types of objects related to a time of day. For example, the content storage network may report that video files are particularly popular for download to users between the hours of 5:00 PM and 7:00 PM. The content storage network may also report that a video file associated with the received content object represents a very popular video. This information can be used to predict network traffic within the time period identified by the content policy. For example, the content policy may allow the content object to be uploaded and distributed to the content storage network within the next 12 hours. By analyzing the received network/usage information, the landing pad can determine that the optimal time for uploading the content object to the rest of the content storage network occurs between the hours of 10:00 PM and 10:30 PM. By looking at the allowable times for upload, and identifying within those times the optimal network traffic and usage bandwidth, the method may include prioritizing upload timing (1208). Prioritizing the upload timing may include creating an upload order for a batch of files received by the landing pad based on their relative importance is determined by their policies and the network/usage information for each file type and instance.

### Exemplary Hardware

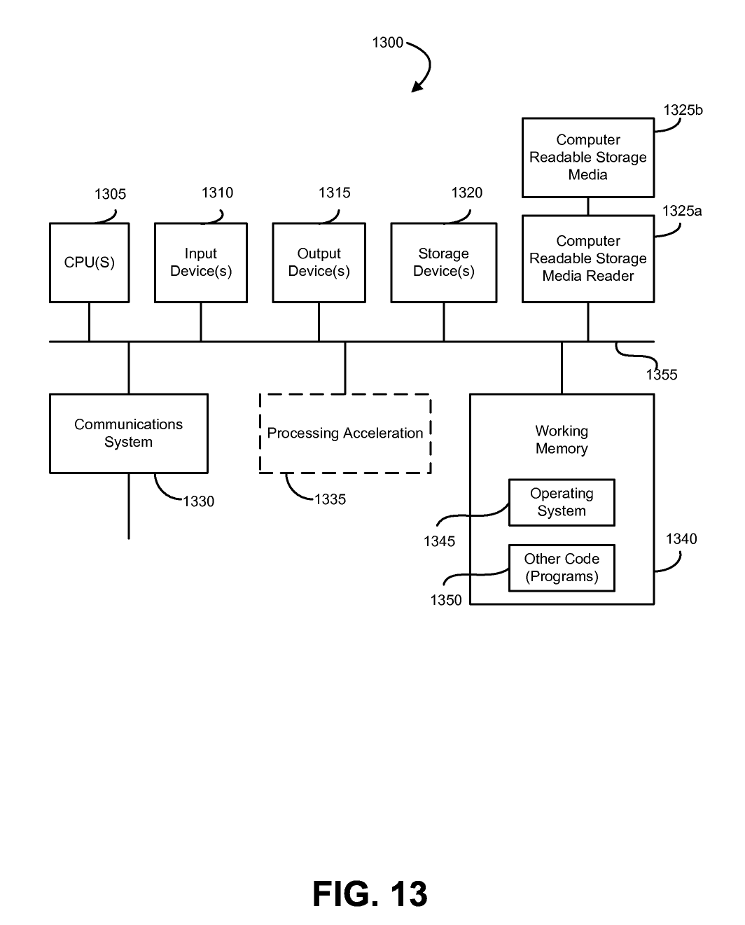

FIG. 13 illustrates an exemplary computer system 1300, in which various embodiments of the present invention may be implemented. The system 1300 may be used to implement any of the computer systems described above. The computer system 1300 is shown comprising hardware elements that may be electrically coupled via a bus 1355. The hardware elements may include one or more central processing units (CPUs) 1305, one or more input devices 1310 (e.g., a mouse, a keyboard, etc.), and one or more output devices 1315 (e.g., a display device, a printer, etc.). The computer system 1300 may also include one or more storage device 1320. By way of example, storage device(s) 1320 may be disk drives, optical storage devices, solid-state storage device such as a random access memory (“RAM”) and/or a read-only memory (“ROM”), which can be programmable, flash-updateable and/or the like.

The computer system 1300 may additionally include a computer-readable storage media reader 1325a, a communications system 1330 (e.g., a modem, a network card (wireless or wired), an infra-red communication device, etc.), and working memory 1340, which may include RAM and ROM devices as described above. In some embodiments, the computer system 1300 may also include a processing acceleration unit 1335, which can include a DSP, a special-purpose processor and/or the like.

The computer-readable storage media reader 1325a can further be connected to a computer-readable storage medium 1325b, together (and, optionally, in combination with storage device(s) 1320) comprehensively representing remote, local, fixed, and/or removable storage devices plus storage media for temporarily and/or more permanently containing computer-readable information. The communications system 1330 may permit data to be exchanged with the network 1320 and/or any other computer described above with respect to the system 1300.

The computer system 1300 may also comprise software elements, shown as being currently located within a working memory 1340, including an operating system 1345 and/or other code 1350, such as an application program (which may be a client application, web browser, mid-tier application, RDBMS, etc.). It should be appreciated that alternate embodiments of a computer system 1300 may have numerous variations from that described above. For example, customized hardware might also be used and/or particular elements might be implemented in hardware, software (including portable software, such as applets), or both. Further, connection to other computing devices such as network input/output devices may be employed. Software of computer system 1300 may include code 1350 for implementing embodiments of the present invention as described herein.

Each of the methods described herein may be implemented by a computer system, such as computer system 1300 in FIG. 13. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed by the computed without human intervention. Therefore, it will be understood in light of this disclosure, that each step and each method described herein may be altered to include an input and output to and from a user, or may be done automatically by a computer system. Furthermore, some embodiments of each of the methods described herein may be implemented as a set of instructions stored on a tangible, non-transitory storage medium to form a tangible software product.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but can have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. A “processing function” may include any hardware processing element, such as a server, a processor, a microcontroller, and/or the like.

While the principles of the disclosure have been described above in connection with specific apparatuses and methods, it is to be clearly understood that this description is made only by way of example and not as limitation on the scope of the disclosure.

What is claimed is:

1. A system for securely managing uploaded content according to client-definable policies in remote storage configurations, the system comprising:
a content storage network comprising a plurality of servers that are distributed in a plurality of geographic regions;
a policy engine that stores and processes policies that govern how content uploaded to the content storage network is stored on the plurality of servers throughout the plurality of geographic regions;
a client portal deployable to a client device for managing content in the content storage network, wherein the client portal is configured to:
receive a content object at the client device for upload to the content storage network;
receive a policy or a selection of a policy that governs how the content object should be stored in the content storage network; and
provide a status of how the policy is applied to the content object after the content object is uploaded to the content storage network.

2. The system for securely managing uploaded content according to client-definable policies in remote storage configurations of claim 1, wherein:
the content storage network comprises a content delivery network (CDN),
the plurality of servers comprises a plurality of edge servers organized into a plurality of geographically distributed Points of Presence (POPs) in the CDN; and
the policy that governs how the content object should be stored in the content storage network governs how copies of the content object should be distributed to the plurality of geographically distributed POPs.

3. The system for securely managing uploaded content according to client-definable policies in remote storage configurations of claim 1, wherein the client portal is further configured to provide a progress indicator while the content object is being uploaded.

4. The system for securely managing uploaded content according to client-definable policies in remote storage configurations of claim 1, wherein the client portal is further configured to accept inputs that define elements of the policy.

5. The system for securely managing uploaded content according to client-definable policies in remote storage configurations of claim 1, wherein:
the client portal is further configured to detect a time interval between when the content object is uploaded and when the content object conforms with the policy; and
during the time interval, the status of how the policy is applied to the content object indicates that the content object does not yet conform to the policy.

6. The system for securely managing uploaded content according to client-definable policies in remote storage configurations of claim 5, wherein:
the client portal is further configured to detect when the content object has been uploaded and when storage of the content object in the content storage network conforms to the policy; and
after the time interval, the status of how the policy is applied to the content object indicates that the content object conforms to the policy.

7. The system for securely managing uploaded content according to client-definable policies in remote storage configurations of claim 1, wherein the client portal comprises a mountable file system in client space that provides virtualized access to the content object after it has been uploaded into the content storage network.

8. The system for securely managing uploaded content according to client-definable policies in remote storage configurations of claim 1, wherein the client portal is configured to transparently encrypt the content object before the content object is uploaded to the content storage network and decrypt the content object when the content object is downloaded to the client portal.

9. The system for securely managing uploaded content according to client-definable policies in remote storage configurations of claim 8, wherein cryptographic keys for decrypting and/or encrypting the content object are stored at the client portal and are not accessible by the content storage network.

10. The system for securely managing uploaded content according to client-definable policies in remote storage configurations of claim 8, wherein the client portal is further configured to:
receive a request to display contents of the content storage network according to a view;
access one or more content objects stored in the content storage network that are associated with the view;
decrypt one or more blocks for each of the one or more content objects, wherein the one or more blocks include preview information; and
cause the preview information to be displayed in an unencrypted form at the client portal.

11. A method for securely managing uploaded content according to client-definable policies in remote storage configurations, the method comprising:
receiving, at a client portal, a content object from a client device for upload to a content storage network, wherein:
the client portal is deployable to the client device for managing content in the content storage network; and
the content storage network comprises a plurality of servers that are distributed in a plurality of geographic regions;
receiving, at the client portal, a policy or a selection of a policy that governs how the content object should be stored in the content storage network, wherein:
a policy engine stores and processes policies that govern how content uploaded to the content storage network is stored on the plurality of servers throughout the plurality of geographic regions; and
providing, at the client portal, a status of how the policy is applied to the content object after the content object is uploaded to the content storage network.

12. The method for securely managing uploaded content according to client-definable policies in remote storage configurations of claim 11, wherein:
the content storage network comprises a content delivery network (CDN),
the plurality of servers comprises a plurality of edge servers organized into a plurality of geographically distributed Points of Presence (POPs) in the CDN; and
the policy that governs how the content object should be stored in the content storage network governs how copies of the content object should be distributed to the plurality of geographically distributed POPs.

13. The method for securely managing uploaded content according to client-definable policies in remote storage configurations of claim 11, further comprising providing, at the client portal, a progress indicator while the content object is being uploaded.

14. The method for securely managing uploaded content according to client-definable policies in remote storage configurations of claim 11, further comprising accepting, at the client portal, inputs that define elements of the policy.

15. The method for securely managing uploaded content according to client-definable policies in remote storage configurations of claim 11, further comprising detecting, at the client portal, a time interval between when the content object is uploaded and when the content object conforms with the policy, wherein during the time interval the status of how the policy is applied to the content object indicates that the content object does not yet conform to the policy.

16. The method for securely managing uploaded content according to client-definable policies in remote storage configurations of claim 15, further comprising detecting, at the client portal, when the content object has been uploaded and when storage of the content object in the content storage network conforms to the policy, wherein after the time interval the status of how the policy is applied to the content object indicates that the content object conforms to the policy.

17. The method for securely managing uploaded content according to client-definable policies in remote storage configurations of claim 11, wherein the client portal comprises a mountable file system in client space that provides virtualized access to the content object after it has been uploaded into the content storage network.

18. The method for securely managing uploaded content according to client-definable policies in remote storage configurations of claim 11, further comprising:
transparently encrypting, at the client portal, the content object before the content object is uploaded to the content storage network; and
transparently decrypting, at the client portal, the content object when the content object is downloaded to the client portal.

19. The method for securely managing uploaded content according to client-definable policies in remote storage configurations of claim 18, wherein cryptographic keys for decrypting and/or encrypting the content object are stored at the client portal and are not accessible by the content storage network.

20. The method for securely managing uploaded content according to client-definable policies in remote storage configurations of claim 18, further comprising, at the client portal:
receiving a request to display contents of the content storage network according to a view;
accessing one or more content objects stored in the content storage network that are associated with the view;
decrypting one or more blocks for each of the one or more content objects, wherein the one or more blocks include preview information; and
causing the preview information to be displayed in an unencrypted form at the client portal.
